(19) United States
(12) Patent Application Publication
(10) Pub. No.: US 2006/0140327 A1
(43) Pub. Date: Jun. 29, 2006

(54) Magnetic bottle system for plasma containment

(76) Inventor: Leonard Joseph Gojer, Dallas, TX (US)

Correspondence Address: LEONARD GOJER, 10802 BRANCH OAKS CR, DALLAS, TX, 75230, US

(21) Appl. No.: 10/717,508

(22) Filed: Mar. 17, 2004

(51) Int. Cl. G21B 1/00

(52) U.S. Cl. 376/121

(57) ABSTRACT

It describes the mechanism of a successful magnetic bottle by describing the necessary electronic components and their design. The invention is a circuit composed of electromagnets and their associated black box inputs that create the necessary magnetic fields to impose a pinch effect on hydrogen ion plasma, creating a working fusion reactor. The black boxes are sin wave generating circuits involving electromagnets, capactors, and transistors and resistors and wires that produce the components of the fourier series of the master signal reference which create the field relationship necessary for fusion to take place. The master signal is a theoretical triangular wave. The theoretical wave is implemented by a spline function which is divided into four functions that add up to create the effect of the original triangle wave. the four functions are implemented by approximation with the fourier series involving two hundred sin waves per spline function. The reason that the circuit works is because the derivative of the magnetic field is constant, creating a constant electric field. This is shown to be true by Faraday's law. The individual torus create an electric field passing through their donut holes perpendicular to the plane of the torus' and parallel to the plane of the master torus wich is covered by another set of wires that add on to the field relationship a vector completes the pinch effect in the master torus so that fusion can take place. The invention works because once the components have been constructed within a certain dimensional framework, the input voltages of the master signals can be raised higher and higher until fusion is achieved.

The invention is a circuit composed of electromagnets and their associated black box inputs that create the necessary magnetic fields to impose a pinch effect on hydrogen ion plasma, creating a working fusion reactor.

There are sixteen torus magnets as shown in the drawing that are arranged in the shape of a spoke arrangement with a cental torus placed perpendicular to the planes of the sixteen torus'. The outer torus' have four wave forms that are passing through four different wires that are superimposed on each other sequentially. the inner torus has a wire system that is parallel to the torus plane, and the outer torus have their wires in the true torus orientation. there is a master power source which is considered a black box source of direct current power.

The black boxes are sin wave generating circuits involving electromagnets, capactors, and transistors and resistors and wires that produce the components of the fourier series of the master signal reference which create the field relationship necessary for fusion to take place. These sin waves a superimposed with addition circuits that are actually induction coils. the ciruit has regulatory mechanisms such as frequency and amplitude and phase shift control in order to keep the fourier series as close to the perfect form as possible.

The master signal is a theoretical triangular wave. The theoretical wave is implemented by a spline function which is divided into four functions that add up to create the effect of the original triangle wave. the four functions are implemented by approximation with the fourier series involving two hundred sin waves per spline function. the reason that the circuit works is because the derivative of the magnetic field is constant, creating a constant electric field. This is shown to be true by Faraday's law.

The individual torus' create an electric field passing through their donut holes perpendicular to the plane of the torus' and parallel to the plane of the master torus wich is covered by another set of wires that add on to the field relationship a vector completes the pinch effect in the master torus so that fusion can take place.

The invention works because once the components have been constructed within a certain dimensional framework, the input voltages of the master signals can be raised higher and higher until fusion reaction is actually achieved.

### CROSS-REFERENCE

None

### REFERENCE TO MICROFICHE APPENDIX OR COMPUTER PROGRAM LISTINGS

The computer programs supplied with the initial application show the computation of the fourier series of the master signals, giving the amplitude of the sin wave generating circuits for the four signals that pass through the outer torus'.

### BACKGROUND OF THE INVENTION

1. Field of the Invention

Electromagnetic physics and plasma physics (as a branch of General Physics)

2. Description of the Related Art (Problem Solved by Invention)

The invention is an act of electrical engineering; that is—understanding the mathematics of the electromagnetical waveforms to the extent of making them contain hydrogen ions. It borrows equations taken from astrophysics;—understanding the physics of the plasma well enough to replicate the interior of stars.

### SUMMARY OF THE INVENTION

It uses the laws of electromagnetism to create the desired pinch effect for constructing a successful magnetic bottle.

1. The claim of thi patent appliction is that the wave-form and it's implementation are the invention of the inventor, whereas, all features of the patent which are not related to the wave-form are public domain knowledge that complement the intention of the wave-form. The wave-form allows for the construction of a successfull magnetic bottle, and the wave-form is buildable with sin wave generating circuitry because of the laws of electricity and electromagnetism. The wave-forms are approximated by the fourier series to two hundred terms of the series, thus two hundred sin wave generators per wave-form, and then applied to the coils of the electromagnets to produce the desired field that creates the pinch effect on the hydrogen ions. The claim of the inventor is that this electromagnetic configuration is unique compared to all configurations that others have tried so far. Furthermore, the inventor claims that the physical dimensions of the electromagnets are variable because the current input can be increased until the pinch effect occurs after the other dimensions of the system have been given arbitrary or derived values, the only limiting criteria being how much energy does the designer want to produce. The claim is that the topology of the wires is an invention of the inventor, and that this topology is the factor that produces a successful design of a fusion reactor.
